SEQUENCE LISTING (9 sequences)

SEQ ID NO: 1 - DNA, 530 bp, Aeromonas enteropelogenes
tggagagtttgatcctggctcagattgaacgctggcggcaggcctaacacatgcaagtcgagcggcagcgggaaagtagcttgctacttttgccggcgagcggcggacgggtgagtaatgcctgggaaattgcccagtcgagggggataacagttggaaacgactgctaataccgcatacgccctacgggggaaagcaggggaccttcgggccttgcgcgattggatatgcccaggtgggattagctagttggtgaggtaatggctcaccaaggcgacgatccctagctggtctgagaggatgatcagccacactggaactgagacacggtccagactcctacgggaggcagcagtggggaatattgcacaatgggggaaaccctgatgcagccatgccgcgtgtgtgaagaaggccttcgggttgtaaagcactttcagcgaggaggaaaggtcagtagctaatatctgctgactgtgacgttactcgcagaagaagcaccggctaactccgtgccagcagccgcggta

SEQ ID NO: 2 - DNA, 528 bp, Enterobacter pyrinus
tggagagtttgatcctggctcagattgaacgctggcggcaggcctaacacatgcaagtcgaacggtaacaggaagtagcttgctactttgctgacgagtggcggacgggtgagtaatgtctgggaaactgcctgatggagggggataactactggaaacggtagctaataccgcataacgtcgcaagaccaaagagggggaccttcgggcctcttgccatcagatgtgcccagatgggattagctagtaggtggggtaacggctcacctaggcgacgatccctagctggtctgagaggatgaccagccacactggaactgagacacggtccagactcctacgggaggcagcagtggggaatattgcacaatgggcgcaagcctgatgcagccatgccgcgtgtatgaagaaggccttcgggttgtaaagtactttcagcggggaggaaggcggtgaggttaataacctcatcgattgacgttacccgcagaagaagcaccggctaactccgtgccagcagccgcggta

SEQ ID NO: 3 - DNA, 526 bp, Klebsiella pneumoniae ozaenae
tggagagtttgatcctggctcagattgaacgctggcggcaggcctaacacatgcaagtcgagcggtagcacagagagcttgctctcgggtgacgagcggcggacgggtgagtaatgtctgggaaactgcctgatggagggggataactactggaaacggtagctaataccgcataacgtcgcaagaccaaagtgggggaccttcgggcctcatgccatcagatgtgcccagatgggattagctggtaggtggggtaacggctcacctaggcgacgatccctagctggtctgagaggatgaccagccacactggaactgagacacggtccagactcctacgggaggcagcagtggggaatattgcacaatgggcgcaagcctgatgcagccatgccgcgtgtgtgaagaaggccttcgggttgtaaagcactttcagyggggaggaaggcgttaaggttaataaccttgkcgattgacgttacccgcagaagaagcaccggctaactccgtgccagcagccgcggta

SEQ ID NO: 4 - DNA, 526 bp, Klebsiella pneumoniae rhinoscleromatits
tggagagtttgatcctggctcagattgaacgctggcggcaggcctaacacatgcaagtcgagcggtagcacagagagcttgctctcgggtgacgagcggcggacgggtgagtaatgtctgggaaactgcctgatggagggggataactactggaaacggtagctaataccgcataacgtcgcaagaccaaagtgggggaccttcgggcctcatgccatcagatgtgcccagatgggattagctagtaggtggggtaayggctcacctaggcgacgatccctagctggtctgagaggatgaccagccacactggaactgagacacggtccagactcctacgggaggcagcagtggggaatattgcacaatgggcgcaagcctgatgcagccatgccgcgtgtgtgaagaaggccttcgggttgtaaagcactttcagcggggaggaaggcgataaggttaataaccttgtcgattgacgttacccgcagaagaagcaccggctaactccgtgccagcagccgcggta

SEQ ID NO: 5 - DNA, 526 bp, Pantoea agglomerans
tggagagtttgatcctggctcagattgaacgctggcggcaggcctaacacatgcaagtcgaacggtagcacagagagcttgctctcgggtgacgagtggcggacgggtgagtaatgtctgggaaactgcctgatggagggggataactactggaaacggtagctaataccgcataacgtcgcaagaccaaagagggggaccttcgggcctcttgccatcagatgtgcccagatgggattagctagtaggcggggtaatggcccacctaggcgacgatccctagctggtctgagaggatgaccagccacactggaactgagacacggtccagactcctacgggaggcagcagtggggaatattgcacaatgggcgcaagcctgatgcagccatgccgcgtgtgtgaagaaggccttcgggttgtaaagcactttcagcggggaggaaggcrgtmcggttaataaccgtgctgattgacgttacccgcagaagaagcaccggctaactccgtgccagcagccgcggta

SEQ ID NO: 6 - DNA, 528 bp, Proteus penneri
tggagagtttgatcctggctcagattgaacgctggcggcaggcctaacacatgcaagtcgagcggtaacagamgaaagcttgctttcttgctgacgagcggcggacgggtgagtaatgtatggggatctgcccgatagagggggataactactggaaacggtrgctaataccgcatraygtctmmrgaccaaagcaggggctcttcggacctykygcyatcrgatgaacccakatgggattagctagtaggtgaggtaayggctcacctaggcgacgatcyctagctggtctgagaggatgatcagccacactggractgagacacggyccagactcctacgggaggcagcagtggggaatattgcacaatgggcgcaagcctgatgcagccatgccgcgtgtatgaagaaggccttagggttgtaaagtactttcagcggggaggaaggtgataaggttaatactcttagcaattgacgttacccgcagaagaagcaccggctaactccgtgccagcagccgcggta

SEQ ID NO: 7 - DNA, 528 bp, Pseudomonas geniculata
tggagagtttgatcctggctcagagtgaacgctggcggtaggcctaacacatgcaagtcgaacggcagcacagargagcttgctcyttgggtggcgagtggcggacgggtgaggaatacatcggaatctactttttcgtgggggataacgtagggaaacttacgctaataccgcatacgacctacgggtgaaagcaggggaccttcgggccttgcgcgattgaatgagccgatgtcggattagctagttggcggggtaaaggcccaccaaggcgacgatccgtagctggtctgagaggatgatcagccacactggaactgagacacggtccagactcctacgggaggcagcagtggggaatattggacaatgggcgcaagcctgatccagccataccgcgtgggtgaagaaggccttcgggttgtaaagcccttttgttgggaaagaaatccagctggctaatacccggttgggatgacggtacccaaagaataagcaccggctaacttcgtgccagcagccgcggta

SEQ ID NO: 8 - DNA, 522 bp, Pseudomonas monteilii
tggagagtttgatcctggctcagattgaacgctggcggcaggcctaacacatgcaagtcgagcggatgacgggagcttgctccttgattcagcggcggacgggtgagtaatgcctaggaatctgcctggtagtgggggacaacgtttcgaaaggaacgctaataccgcatacgtcctacgggagaaagcaggggaccttcgggccttgcgctatcagatgagcctaggtcggattagctagttggtggggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggcagtaagttaataccttgctgttttgacgttaccgacagaataagcaccggctaactctgtgccagcagccgcggta

SEQ ID NO: 9 - DNA, 522 bp, Pseudomonas plecoglossicida
tggagagtttgatcctggctcagattgaacgctggcggcaggcctaacacatgcaagtcgagcggatgacgggagcttgctccttgattcagcggcggacgggtgagtaatgcctaggaatctgcctggtagtgggggacaacgtttcgaaaggaacgctaataccgcatacgtcctacgggagaaagcaggggaccttcgggccttgcgctatcagatgagcctaggtcggattagctagtaggtgaggtaatggctcacctaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggttgtacgctaataccgtgcaattttgacgttaccgacagaataagcaccggctaactctgtgccagcagccgcggta

(19) United States
(12) Patent Application Publication
(10) Pub. No.: US 2006/0194303 A1
(43) Pub. Date: Aug. 31, 2006

(54) Wastewater treatment compositions

(75) Inventors: Gerald A. DeWitt, Jesup, GA (US); David W. Rogers, Brunswick, GA (US); Clifford Lange, Auburn, AL (US); John Christiansen, The Woodlands, TX (US); Matt Tatarko, Radford, VA (US); John Thomas Cenicola JR., St. Simons Island, GA (US)

Correspondence Address: NOVOZYMES NORTH AMERICA, INC., 500 FIFTH AVENUE, SUITE 1600, NEW YORK, NY, 10110, US

(73) Assignees: Novozymes Biologicals, Inc., Salem, VA (US); Rayonier Inc., Jacksonville, FL (US)

(21) Appl. No.: 11/312,072

(22) Filed: Dec. 20, 2005

Related U.S. Application Data
(60) Provisional application No. 60/637,908, filed on Dec. 21, 2004.

(51) Int. Cl. C02F 3/34; B01D 43/00

(52) U.S. Cl. 435/262; 210/601

(57) ABSTRACT

The present invention relates to a wastewater treatment composition and a process of decolorizing pulp and paper mill wastewater and, more specifically, to a process for treating wastewater effluent from a pulp or paper mill with a microorganism whereby color bodies in the pulp and paper wastewater are thereby removed and the wastewater is decolorized.

### CROSS-REFERENCE TO RELATED APPLICATIONS

This application claims priority or the benefit under 35 U.S.C. 119 of U.S. provisional application no. 60/637,908 filed Dec. 21, 2004, the contents of which are fully incorporated herein by reference.

### REFERENCE TO SEQUENCE LISTING AND DEPOSITED MICROORGANISMS

The present application contains information in the form of a sequence listing, which is appended to the application and also submitted on a data carrier accompanying this application. In addition, the present application refers to deposited microorganisms. The contents of the data carrier and the deposited microorganisms are fully incorporated herein by reference.

### BACKGROUND OF THE INVENTION

1. Field of the Invention

The present invention relates to a wastewater treatment composition and a process of decolorizing pulp and paper mill wastewater and, more specifically, to a process for treating wastewater effluent from a pulp or paper mill with a microorganism whereby color bodies in the pulp and paper wastewater are thereby removed and the wastewater is decolorized.

2. Description of Related Art

Pulp and paper mill wastewaters are generally obtained as a result of manufacturing processes for the preparation of wood pulp and paper. Due to the presence of organic and inorganic materials in such wastewaters rendering such wastewaters unsuitable for reuse and undesirable for release into the biosphere due to the pollution problems which result when they are discharged untreated, pulp and paper mill wastewaters are generally processed in biological treatment systems, for example, aerated lagoons or activated sludge systems, for removal of biodegradable organic matter prior to reuse or discharge to receiving bodies of water.

While the biological processes occurring during such a biological treatment provide the ability to produce effluent which has both low biological oxygen demand (BOD) and low chemical oxygen demand (COD), unfortunately, conventionally employed biological treatment systems accomplish very little, if any, reduction in color of the pulp and paper mill wastewater when the pulp and paper wastewater is so treated. For example, trickling filters have been recommended by governmental environmental regulatory agencies for use in processing wastewater effluent from pulp and paper mills. However, no color removal has been achieved (see H. T. Chen et al., “Four Biological Systems for Treating Integrated Paper Mill Effluent,” TAPPI, 57, 5 (11-115) (1974)).

Also, a system comprising plastic disks on a single shaft which is rotated (as disclosed in D. J. Bennett et al., “Pilot Application of the Rotating Biological Surface Concept for Secondary Treatment of Insulating Board Mill Effluents,” TAPPI, 56, 12 (182-187) (1973) and an activated sludge treatment using oxygen instead of air (as disclosed in R. J. Grader et al., “The Activated Sludge Process Using High-Purity for Treating Kraft Mill Wastewater,” TAPPI, 56, 4 (103-107) (1973)) have been used, but no reduction in color of paper mill waste has been reported using either system. In some instances, it has been observed that an increase in true color in actuality occurs.

From this observed result, it is apparent that the aerobic bacteria typically present in such treatment systems are not capable of utilizing the color bodies which are present in the wastewater from pulp and paper processing as a source of food. Even with the well-known ability and adaptability of bacteria to adjust to and utilize new substrates as food sources, thus far the development of bacteria capable of reducing color in pulp and paper mill wastewater effluent has not been reported. Successful anaerobic treatment of pulp & paper wastewaters has been reported using anaerobic lagoons, and anaerobic upflow sludge blanket reactors (see T. G. Jantsch, et al, Bioresource Technology (2002) 84: 15-20 and G. Vidal, et al, Bioresource Technology (2001) 77: 183-191). However, no data has been presented on sustained color removal processes using this technology.

Whereas regulatory guidelines for paper mill waste color have not been set forth, much work has been done to evaluate the various physical-chemical methods for removing color, such as lime precipitation, resin separation, activated carbon adsorption, and ozonation, all with varied degrees of success and in all cases involving high cost for initial capital equipment and ongoing operating and maintenance expenditures. Refer to review article for chemical physical methods, “Current Status of the Effluent Decolorization Problem,” by Isiah Gellman and Herbert F. Berger. TAPPI, Volume 57, No. 9 (September 1974).

With the increasing concern as to minimization of the problems arising from pollution, biological processes utilizing microorganisms are being industrially employed in an increasing amount, and a large amount of activity in research and development is occurring presently to develop new microbial strains capable of use in wastewater treatment both industrially and domestically. Even with this increased activity in investigating and developing strains of microorganisms to solve particular waste removal problems, no reduction in color which exists in effluent wastewater from pulp and paper mills has been achieved.

Polyporus versicolor has been used to degrade color bodies in paper mill effluent, but such was in the presence of carbohydrates. However, no significant reduction was seen in the absence of carbohydrates (e.g., as disclosed in Marton and Stern, “Decolorization of Kraft Black Liquor with Polyporus versicolor, a White Fungus,” TAPPI, 52, 10 (1969)). Furthermore, filamentous organisms such as Polyporus versicolor are impractical for use in biological treatment systems.

U.S. Pat. No. 4,199,444 discloses the use of a strain of Pseudomonas aeruginosa for decolorizing pulp and paper mill wastewater.

It is an object of this invention is to provide an improved biological process for treatment of pulp and paper mill wastewater effluent.

### SUMMARY OF THE INVENTION

The present invention provides microbial wastewater treatment compositions comprising a strain of a microorganism selected from the group consisting of Aeromonas enteropelogenes, Enterobacter pyrinus, Klebsiella pneumoniae, Pantoea agglomerans, Proteus penner, Pseudomonas geniculata, Pseudomonas monteilii, and Pseudomonas plecoglossicida.

In one embodiment, the present invention provides microbial wastewater treatment compositions and the use of the wastewater treatment compositions to remove or reduce color in wastewater, such as pulp and paper mill wastewater.

The present invention also relates to a process of reducing chemical oxygen demand in a wastewater and biologically pure cultures of one or more microbial strains.

### BRIEF DESCRIPTION OF THE FIGURES

FIG. 1 shows the degradation of color over time of a strong pond waste stream by pure and a mixed culture of isolated microorganisms.

FIG. 2 shows decolorization over time of a strong pond waste stream by pure and a mixed culture of isolated microorganisms.

FIG. 3 shows decolorization over time of a strong pond waste stream by pure and a mixed culture of isolated microorganisms.

FIG. 4 shows decolorization over time of a strong pond waste stream by a mixed culture of isolated microorganisms.

FIG. 5 shows the color removal results of Strong Pond Effluent (Alkaline Pulp Mill Wastewater) treated by a biologically active wood fiber matrix.

FIG. 6 shows the color removal of a bleach plant filtrate treated by a microbial consortium in an AnSBR in an Anaerobic Sequencing Batch Reactor (AnSBR).

FIG. 7 shows the removal of organic halides in a bleach plant filtrate treated by a microbial consortium in an AnSBR.

FIG. 8 shows color removal of wastewater by biologically active waste wood fiber at different solids (kg) to liquid waste (L/day) ratios, or Mass:Food (M:F) ratios.

FIG. 9 shows the removal of methanol in an experiment in which an E Stage Bleached Plant Filtrate treated by a microbial consortium in an AnSBR was spiked with methanol at 100 mg/L and 500 mg/L.

FIG. 10 shows color removal of six wastewaters using a waste wood fiber containing a microbial consortium.

FIG. 11 shows color removal in D Stage and E Stage wastewater.

FIG. 12 shows color removal at different polymer concentrations.

FIG. 13 shows color removal in a down flow periodic reactor.

### DETAILED DESCRIPTION OF THE INVENTION

Wastewater Treatment Compositions

The present invention relates to wastewater treatment compositions comprising a strain of a microorganism selected from the group consisting of Aeromonas enteropelogenes, Enterobacter pyrinus, Klebsiella pneumoniae, Pantoea agglomerans, Proteus penner, Pseudomonas geniculata, Pseudomonas monteilii, and Pseudomonas plecoglossicida.

A consortium of Aeromonas enteropelogenes, Enterobacter pyrinus, Klebsiella pneumoniae, Pantoea agglomerans, Proteus penneri, Pseudomonas geniculata, Pseudomonas monteilii, and Pseudomonas plecoglossicida was isolated from natural sources. It was deposited for patent purposes under the terms of the Budapest Treaty at the ATCC (American Type Culture Collection), 10801 University Blvd., Manassas, Va. 20108. The deposit was made on May 20, 2004 by Novozymes Biologicals Inc. and was accorded deposit number PTA-6005.

In a preferred embodiment, the wastewater treatment composition comprises a strain of two, preferably three, more preferably four, even more preferably five, and most preferably six microorganisms selected from the group consisting of Aeromonas enteropelogenes, Enterobacter pyrinus, Klebsiella pneumoniae, Pantoea agglomerans, Proteus penneri, Pseudomonas geniculata, Pseudomonas monteilii, and Pseudomonas plecoglossicida.

In another preferred embodiment, the wastewater treatment composition comprises a strain of Aeromonas enteropelogenes. Preferably, the Aeromonas enteropelogenes strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with SEQ ID NO: 1 or its complementary strand.

In another preferred embodiment, the wastewater treatment comprises a strain of Enterobacter pyrinus. Preferably, the Enterobacter pyrinus strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with SEQ ID NO: 2 or its complementary strand.

In another preferred embodiment, the wastewater treatment composition comprises a strain of Klebsiella pneumoniae and more preferably a strain of Klebsiella pneumoniae ozaenae or Klebsiella pneumoniae rhinoscleromatis. Preferably, the Klebsiella pneumoniae ozaenae strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with SEQ ID NO: 3 or its complementary strand. Preferably, the Klebsiella pneumoniae rhinoscleromatits strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with SEQ ID NO: 4 or its complementary strand.

In another preferred embodiment, the wastewater treatment composition comprises a strain of Pantoea agglomerans. Preferably, the Pantoea agglomerans strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with SEQ ID NO: 5 or its complementary strand.

In another preferred embodiment, the wastewater treatment composition comprises a strain of Proteus penneri. Preferably, the Proteus penneri strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with SEQ ID NO: 6 or its complementary strand.

In another preferred embodiment, the wastewater treatment composition comprises a strain of Pseudomonas geniculata. Preferably, the Pseudomonas geniculata strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with SEQ ID NO: 7 or its complementary strand.

In another preferred embodiment, the wastewater treatment composition comprises a strain of Pseudomonas monteilii. Preferably, the Pseudomonas monteilii strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with SEQ ID NO: 8 or its complementary strand.

In another preferred embodiment, the wastewater treatment composition comprises a strain of Pseudomonas plecoglossicida. Preferably, the Pseudomonas plecoglossicida strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with SEQ ID NO: 9 or its complementary strand.

For purposes of the present invention, the degree of identity between two nucleotide sequences is determined by the Wilbur-Lipman method (Wilbur and Lipman, 1983, Proceedings of the National Academy of Science USA 80: 726-730) using the LASERGENE™ MEGALIGN™ software (DNASTAR, Inc., Madison, Wis.) with an identity table and the following multiple alignment parameters: Gap penalty of 10 and gap length penalty of 10. Pairwise alignment parameters are Ktuple=3, gap penalty=3, and windows=20.

Hybridization means that a nucleotide sequence hybridizes to a labeled nucleic acid probe having a nucleotide sequence of any of SEQ ID NOs: 1-9, a cDNA sequence thereof, or a complementary strand thereof, under low to very high stringency conditions. Molecules to which the nucleic acid probe hybridizes under these conditions can be detected using X-ray film.

Low to very high stringency conditions are defined as prehybridization and hybridization at 42° C. in 5×SSPE, 0.3% SDS, 200 micrograms/ml sheared and denatured salmon sperm DNA, and either 25% formamide for low stringencies, 35% formamide for medium and medium-high stringencies, or 50% formamide for high and very high stringencies, following standard Southern blotting procedures for 12 to 24 hours optimally. The carrier material is finally washed three times each for 15 minutes using 2×SSC, 0.2% SDS preferably at least at 50° C. (low stringency), more preferably at least at 55° C. (medium stringency), more preferably at least at 60° C. (medium-high stringency), even more preferably at least at 65° C. (high stringency), and most preferably at least at 70° C. (very high stringency).

In a most preferred embodiment, the wastewater treatment composition comprises at least one microorganism selected from the group consisting of Aeromonas enteropelogenes, Enterobacter pyrinus, Pantoea agglomerans, and Pseudomonas plecoglossicida and at least one microorganism selected from the group consisting of Klebsiella penumoniae, Proteus penneri, Pseudomonas geniculata, and Pseudomonas monteilii. Even more preferably, the composition comprises (a) Enterobacter pyrinus or Pseudomonas plecoglossicida and (b) Pseudomonas monteilii. In particular, the composition comprises Aeromonas enteropelogenes, Enterobacter pyrinus, Pseudomonas geniculata, Pseudomonas monteilii, and Pseudomonas plecoglossicida.

The strains may be wild-type or mutant strains.

In a preferred embodiment, the composition comprises the microorganism at a concentration of 1×10² to 1×10⁹ colony forming units (CFU)/mL, preferably 1×10⁶ to 1×10⁹ colony forming units (CFU)/mL. When the composition contains more than one microorganism, each microorganism is present at a concentration of 1×10⁶ to 0.5×10⁹ colony forming units (CFU)/mL.

In another preferred embodiment, the composition further comprises nutrients for the microorganism(s). For example, the nutrients may be an inorganic phosphorus compound, particularly a soluble phosphate or an ortho phosphate, preferably, phosphoric acid, mono, di, or tri sodium phosphate, or diammonium phosphate. In addition, the nutrients may be ammonia (NH₃) or an ammonium (NH⁴⁺) salt, preferably anhydrous ammonia, ammonia-water solutions, ammonium nitrate, or diammonium phosphate. The nutrients may also be trace metals, preferably aluminum, antimony, barium, boron, calcium, cobalt, copper, iron, lead, magnesium, manganese, molybdenum, nickel, strontium, titanium, tin, zinc, and/or zirconium.

In another preferred embodiment, the composition further comprises a sugar selected from the group consisting of arabinan, arabinose, cellulose, fructose, galactan, galactose, glucan, glucose, mannan, mannose, sucrose, xylan, and xylose, or wood fiber, wood pulp, or other pulping byproducts. Preferably, the composition comprises the sugar at a concentration between 100 and 400 mg/L, when the sugar is a monosaccharide and a concentration between 8,000 and 15,000 mg/L, when the sugar is a polysaccharide.

All of the strains are gram-negative non-spore forming rods. They all are aerobic to facultative anaerobic with the exception of Ps. monteilii which was found to be a strict aerobic organism. All are heterotrophic organisms growing on complex or defined media. A typical complex media composes of tryptone (5.0 grams/liter), yeast extract (2.5 grams/liter), dextrose (1.0 gram/liter). A typical defined media has a composition (g/L): glucose (10.0) NH₄Cl (0.8), MgSO₄ (0.2), CaCl₂—H₂(0.01), NaPO₄ (4.2), KH₂PO₄ (1.5), FeCl₃ (0.005), FeSO₄-7H₂O (0.00028), ZnSO₄-7H₂O (0.0014), MnSO₄-H₂O (0.00084), CoCl₂-6H₂O (0.00024) CuSO₄-5H₂O (0.00025), and NaMoO₄-2H₂O (0.00024). These organisms are routinely cultured at temperatures from 20-35° C.

Process for Reducing or Removing Color, Halides or Methanol in Wastewater and for Reducing Chemical Oxygen Demand

The present invention also relates to a process of reducing or removing color, halides or methanol or for reducing chemical oxygen demand in a wastewater, comprising treating the wastewater with a wastewater treatment composition of the present invention.

The strains used in the present invention can be cultured in wastewater from a pulp or paper mill either using a batch process, a semi-continuous process or a continuous process, and such is cultured for a time sufficient to degrade the colorant materials present in the wastewater and remove them or break them down into components capable of being degraded by other organisms normally found in biological wastewater treatment systems. In general, the treatment is conducted for a sufficient time to achieve the reduction in color desired and, in general, about 24 hours to about 8 weeks or longer, although this will depend upon the temperature of culturing, the liquor concentration and volume to be treated and other factors, has been found to be suitable. In a preferred embodiment, the wastewater is treated with the microorganism(s) for between 2 hours and 14 days, preferably between 2 hours and 5 days.

The microbial strains of this invention can be employed in ion exchange resin treatment systems, in trickling filter systems, in carbon adsorption systems, in activated sludge treatment systems, in outdoor lagoons or pools, etc. In another preferred embodiment, color is removed in a down flow treatment reactor.

Basically, all that is necessary is for the microorganism(s) to be placed in a situation of contact with the wastewater effluent from a pulp or paper mill. In order to degrade the material present in the wastewater, the wastewater is treated with the organism(s) at a temperature between 15° C. and 45° C., preferably between 20° C. and 45° C., more preferably between 18° C. and 37° C., and most preferably between 30° C. and 35° C. Desirably, the pH is maintained in a range of 4 and 10, preferably 6.0 to 8.5, and most preferably between 6.7 and 7.8. The pH can be controlled by monitoring of system and an addition of appropriate pH adjusting materials to achieve this pH range.

The treatment can be conducted under aerobic or anaerobic conditions. When aerobic conditions are used, the treatment is conducted at a dissolved oxygen concentration of between 0.5 and 7.0 milligrams per liter. These conditions can be simply achieved in any manner conventional in the art and appropriate to the treatment system design being employed. For example, air can be bubbled into the system, the system can be agitated, a trickling system can be employed, etc. In an aerobic process, the treatment is done at a REDOX potential between −200 mV and 200 mV, preferably between 0 mV and 200 mV. When anaerobic conditions are used, the treatment is done at a REDOX potential between −550 mV and −200 mV.

In a preferred embodiment, the wastewater treatment comprises 1-5 cycles, preferably 1 cycle or two cycles, of treatment with the microorganism(s). Preferably, each cycle comprises alternating aerobic and anaerobic treatments. More preferably, the first cycle is conducted under anaerobic conditions. In a preferred embodiment, the cycles are conducted in a sequencing batch reactor. In another preferred embodiment, the process further comprises adding an alkali is added between cycles.

The wastewater to be subjected to the process of this invention may contain sufficient nutrients, e.g., nitrogen and phosphorus, for culturing without the need for any additional source of nitrogen or phosphorus being added. However, in the event the wastewater is deficient in these components, nutrients can be added to the wastewater. For example, phosphorous can be supplemented, if necessary, by addition of a phosphorous source such an inorganic phosphorus compound, particularly a soluble phosphate or an orthophosphate, preferably, phosphoric acid, mono, di, or tri sodium phosphate, or diammonium phosphate, to achieve a phosphorus level in the wastewater of about 1 ppm or more per 100 BOD₅. Similarly, a nitrogen source, such as ammonia (NH₃), urea, or an ammonium salt, preferably anhydrous ammonia, ammonia-water solutions, ammonium nitrate, or diammonium phosphate, can be added to achieve an available nitrogen content of at least about 10 ppm or more per 100 BOD₅.

In another embodiment, the nutrients comprise trace metals, preferably aluminum, antimony, barium, boron, calcium, cobalt, copper, iron, lead, magnesium, manganese, molybdenum, tin, or zinc.

Preferably, the wastewater is a pulp and paper mill wastewater such as strong or concentrated pulp mill wastewater, weak black liquor, acid stage bleach plant filtrate, or alkaline stage bleach plant filtrate.

The process also can be used to treat waste color solids or waste color bodies from chemical color separation processes commonly used in wastewater treatment, including gravity clarifiers, gas flotation units, or in filtration processes such as membrane processes.

In another preferred embodiment, the ratio of solids to liquid waste is between 1:50 to 10:1 preferably 1:10 to 5:1.

In another preferred embodiment, the wastewater passes through wood fibers at anaerobic conditions, particularly in a packed biological reactor or column, an artificial wetland, or an anaerobic sequencing batch reactor (AnSR). Alternatively, the wastewater passes through a mass comprising waste wood fiber from a pulp & paper process, lime, and fly ash. Preferably, the wastewater passes through wood fiber together with cellulosic fiber, plastic, powdered or ceramic media. The rate of the wastewater is preferably 0.05-1 liter wastewater/day per kilogram of wet wood fiber mass.

In a most preferred embodiment, wood fiber is used as a biological medium at anaerobic conditions, comprising one or more of the following steps of: (a) sequencing batch reactors, (b) a facultative lagoon or a stabilization basin, (c) an activated sludge system, (d) coagulation and flocculation followed by settling, and (e) filtration.

The wastewater may be treated with the microorganism(s) in the presence of an electron acceptor, particularly chloroethanes, chloroform, chlorolignins, chloromethanes, chlorophenols, humates, lignin, quinines, or sulfonated lignins.

The microorganisms of the present invention can be employed alone or in combination with conventionally means for decolorizing wastewater, e.g., chemical (e.g., alum, ferric, lime or polyelectrolytes), biological (e.g., white rot fungus), and physical processes (e.g., ultrafiltration, ion exchange and carbon absorption).

In the above manner, difficultly degradable color bodies, as well as other organic compounds which might be present in such wastewater streams, can be advantageously treated to provide treated wastewater suitable for discharge after any additional conventional processing such as settling, chlorination, etc. into rivers and streams. The color bodies are preferably removed by coagulation or flocculation followed by settling, filtration, or flotation.

The present invention also relates to a process of decolorizing a wastewater, comprising treating the wastewater with compost. Compost, which is a combination of fiber, ash, lime, and water, acquires the native culture of microorganisms by aging over several years, and is called “aged compost”. In a preferred embodiment, the compost is Primary Clarifier underflow solids, which contains fresh fiber.

Preferably, the optimum mixture is two parts aged compost and one part fresh fiber, e.g., from the mill's screen room sewer. In a preferred embodiment, this “mixed compost” is combined at two parts to 1 part Pulp Mill wastewater (Strong Waste). After initial mixing, this mixture is preferably allowed to be static for 24 hours, followed by decanting the free liquid and replacing with fresh Strong Waste and a nutrient amendment, which is shown in the table below. After refilling, the mixture is preferably allowed to be static for 24 additional hours, and the decanting and refilling are repeated. The compost is then ready to be used in a Sequencing Batch Reactor (SBR) for color removal. With the correct compost mixture and the acclimation step, the color removal process rapidly reaches 50% in less than 48 hours.

TABLE
Nutrient Amendment for Acclimation Only

| | | Concentration, |
|---|---|---|
| Ingredient | Chemical formula | g/L |
| Potassium dibasic phosphate | KH₂PO₄ | 0.053 |
| Potassium Biphosphate | K₂HPO₄ | 0.107 |
| Ammonium Chloride | NH₄CL | 1.000 |
| Sodium Sulfate | Na₂SO₄ | 2.000 |
| Potassium Nitrate | KNO₃ | 2.000 |
| Calcium Chloride | CaCl₂ | 0.735 |
| Magnesium Sulfate Pentahydrate | MgSO₄—7H₂O | 0.200 |

On an ongoing basis, it may not be necessary to add the nutrient amendment specified in the table. Instead, the operator may monitor soluble phosphate (ortho phosphate) in the color removal reactor effluent. As long as ortho phosphate exceeds 0.2 mg/L the process proceeds. Some phosphorus may be liberated from the process.

The color can be measured using the NCASI process (“An Investigation of Improved Procedures for Measurement of Mill Effluent and Receiving Water Color,” NCASI Technical Bulletin #253 (December 1971)). A brief summary of the method is as follows. The pH of a sample is adjusted to pH 7.6±0.5 with phosphate buffer. The particulate materials in the samples are removed by either filtering through a 0.8 micro-m filter or by centrifugation at 10,000×g for ten minutes. One Platinum Cobalt Unit (“PCU”) of color is the color produced by 1 mg platinum/liter in the form of chloropiatinate ion at 465 nm.

Cultures

The present invention also relates to a biologically pure culture of a strain of microorganism of the present invention.

The following examples are given as exemplary of the invention but without intending to limit the same. Unless otherwise indicated herein, all parts, percents, ratios and the like are by weight.

### EXAMPLES

### Example 1

Samples were collected at Rayonier compost pits (Jesup, Ga.) and processed for bacteria capable of mediating the destruction of the color components of the waste stream.

Initial plating of the bacteria was performed on one of the following media to ensure a wide variety of phenotypes:

1) tryptone (5.0 g/L), yeast extract (2.5 g/L), dextrose (1.0 g/L) and agar (15.0 g/L);

2) SSC (1000 mL), powdered cellulose (10.0 g/L) and agar (15 g/L);

3) SSC (1000 mL), xylose (10.0 g/L) and agar (15 g/L);

4) SSC (1000 mL), xylan (10.0 g/L) and agar (15 g/L).

The composition of SSC (g/L) was: NH₄Cl (0.8), MgSO₄ (0.2), CaCl₂H₂O (0.01), NaPO₄ (4.2), KH₂PO₄ (1.5), FeCl₃ (0.005), FeSO₄.7H₄O (0.00028), ZnSO₄.7H₂O (0.0014), MnSO₄.H₂O (0.00084), CoCl₂.6H₂O (0.00024), CuSO₄.5H₂O (0.00025), and NaMoO₄.2H₂O (0.00024).

Colonies were randomly picked restreaked for isolation and screened for the ability to mediate the destruction of the color components found in the waste stream. These organisms were screened in a medium containing filter sterilized “strong pond” waste stream supplemented with SSC and the addition of the indicated carbon source, 0.1% calcium carbonate. These were incubated under anaerobic conditions at 35° C. After three to five days of growth, the tubes were visually inspected for a decrease in color. In some instances, those not showing an appreciable decrease in color were further incubated for addition times up to 27 days. Samples showing over 20% color removal were analyzed again for their ability to decolorize the waste stream. Over 180 individual isolates were tested in this fashion.

All samples were assayed by the NCASI 71.01 method with the exception that the samples were centrifuged at 14,000×g for 10 minutes to remove particulates. The results of these analyses are shown in Table 1.

TABLE 1

| | | Substrate | | | | | |
|---|---|---|---|---|---|---|---|
| 16S rDNA | Incubation | | 1% | 1% | 1% | 1% | 0.025% |
| Identification | Time | None | Glucose | Xylose | Xylan | Cellulose | Methanol |
| Pantoea | 3 Days | 27% | 48% | Vis^{a} | ND^{b} | ND | 30% |
| agglomerans | | | | | | | |
| 4(bg) | | | | | | | |
| Enterobacter | 3 Days | 20% | 52% | Vis | ND | ND | 41% |
| pyrinus | | | | | | | |
| Enterobacter | 3 Days | 16% | 35% | Vis | ND | ND | 26% |
| pyrinus | | | | | | | |
| Aeromonas | 3 Days | 20% | 37% | Vis | ND | ND | 22% |
| enteropelogenes | | | | | | | |
| Pseudomonas | 3 Days | 20% | 24% | Vis | ND | ND | 0% |
| plecoglossicida | | | | | | | |
| Pseudomonas | 5 Days | ND | 83% | 59% | 15% | 27% | ND |
| geniculata | | | | | | | |
| Pseudomonas | 5 Days | ND | 37% | 5% | 10% | 22% | ND |
| monteilii | | | | | | | |
| Klebsiella | 5 Days | ND | 14% | 37% | 16% | 6% | ND |
| pneumoniae | | | | | | | |
| rhinoscleromatis | | | | | | | |
| Proteus penneri + | 5 Days | ND | 37% | 64% | 22% | 20% | ND |
| Klebsiella | | | | | | | |
| pneumoniae | | | | | | | |
| ozaenae | | | | | | | |

^{a}Only a visual assessment was made of distinct color removal.
^{b}Not performed.

The bacterial species demonstrating good color removal were subjected to DNA extraction, amplification of all or part of the DNA sequence encoding a 16S ribosomal RNA subunit, and sequencing of the amplicon. To eliminate the possibility of duplication of isolates, promising isolates were subjected to biochemical analysis by BioLog and the Enterotube II microbial identification systems. This was compared to the MicroSeq® data base. Further analysis was performed using a discontiguous Mega BLAST search (default search parameters) of all published DNA sequences. The results are shown in Table 2.

TABLE 2
PARTIAL IDENTIFICATION OF ISOLATES FROM RAYONIER

| | | Confidence | | | | |
|---|---|---|---|---|---|---|
| | | Level of 16S | | | | |
| | 16S rDNA | rDNA | | BioLog | | % |
| Isolate | Identification | Identification | BioLog | Probability | BLAST Search | Identity |
| 1 | Pantoea | No Match | Pantoea | IDAP* | Klebsiella | 99% |
| | agglomerans | | dispersia | | pneumoniae | |
| | 4(bg) | | | | | |
| 2** | Enterobacter | No Match | Leclecira | IDAP | Bacterium G13 | 100% |
| | pyrinus | | adecarboxlata | | | |
| 3 | Aeromonas | Species | Aeromonas | 100% | Uncultured | 100% |
| | enteropelogenes | | hydrophilia | | bacterium clone | |
| | | | DNA group 1 | | I19 | |
| 4 | Pseudomonas | Genus | Pseudomonas | 100% | Pseudomonas sp. | 100% |
| | plecoglossicida | | maculicola | | C81E | |
| 5** | Enterobacter | No Match | Enterobacter | IDAP | Bacterium G13 | 97% |
| | pyrinus | | amnigenus | | | |
| 6 | Pseudomonas | Species | Xanthomonas | IDAP | Stenotrophomonas | 99% |
| | geniculata | | campestris | | Maltophilia | |
| 7 | Pseudomonas | Species | Pseudomonas | 94% | Pseudomonas | 100% |
| | monteilii | | putida biotype | | nitroreducens | |
| | | | A | | | |
| 8 | Klebsiella | Species | Serratua | 100% | Uncultured | 99% |
| | pneumoniae | | ficaria | | Bacterium | |
| | rhinoscleromatis | | | | (Klebsiella) | |
| 9 | Proteus penneri | Species | ND | ND | Swine Manure | 95% |
| | | | | | Bacterium RT13A | |
| 10 | Klebsiella | Species | Serratia | IDAP | Klebsiella milletis | 99% |
| | pneumoniae | | ficaria | | | |
| | ozaenae | | | | | |

*Insufficient data to assign probability
**Even though isolates 2 and 5 have the same sequence, BioLog demonstrates different utilizations of carbohydrates.

### Example 2

Optimization of Degradation of Color Components

The degradation of color over time of the “strong pond” waste stream by pure and a defined mixed culture of the isolates. A media buffered with 100 mM 3-(N-morpholino) propane sulfonic acid (MOPS), pH 7.5, with 1% glucose and SSC was prepared (MPG). Isolated colonies of the individual bacteria scraped from plates and 100 mL of filter sterilized strong pond waste stream in 100 mL crimp sealed serum vials. The cells were added to the following final densities: Isolate 1 (Pantoea agglomerans)=5.6×10⁶ CFU/mL, Isolate 5 (Enterobacter pyrinus var 1)=2.0×10⁷ CFU/mL, Isolate 2 (Enterobacter pyrinus var 2)=4×10⁷ CFU/mL, Isolate 3 (Aeromonas enteropelogenes)=2.16×10⁸ CFU/mL and Isolate 4 (Pseudomonas plecoglossicida)=9.06×10⁷ CFU/mL. A mixture of all organisms was added to a final concentration of 7.5×10⁷. The cultures were incubated at 35° C. The strong pond waste stream was also treated with controls consisting of all of the components except for the addition of the organisms. At the indicated times, a sample was drawn though the septa with a sterile syringe and assayed by the NCASI method except that the sample was centrifuged at 14,000×g for 10 minutes to remove particulates.

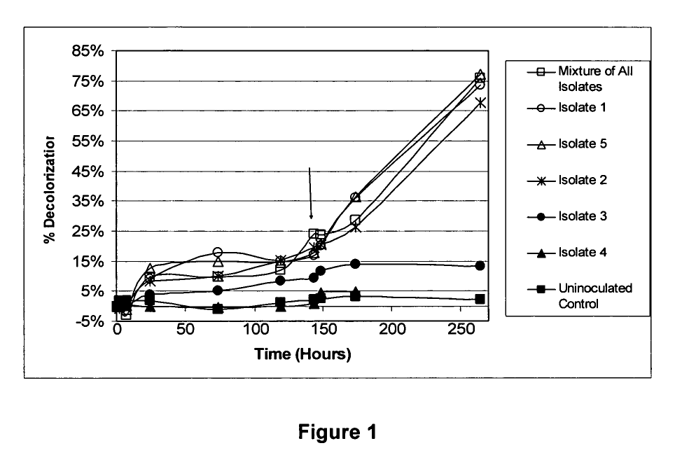

There was a rapid decrease in pH followed closely by the decrease in the destruction of the colored material in the waste stream. In order to circumvent this pH drop, a synthetic ground clam shells was added in the form of sterile slurry of CaCO₃. The pH rose to around pH 6.0, and the degradation rate of the colored material increased. The pH remained around pH 6.0 for the remainder of the experiment. The decolorization results are shown in FIG. 1. The arrow indicates the addition of calcium carbonate.

Another experiment was set up to test the effect of calcium carbonate on the degradation of color. In this experiment, approximately 1 gram calcium carbonate was added from the beginning with 1% glucose and SSC added to the media. These cultures were incubated at 35° C. for 46 hours. All organisms were added at an approximate final concentration ranging from 1×10⁷ to 1×10⁸ CFU/mL. The results are shown in the following table in which the percent decolorization was determined by the NCASI method, as described.

| Culture | Percent Decolorization |
|---|---|
| Isolate 1 | 60% |
| Isolate 5 | 39% |
| Isolate 2 | 61% |
| Isolate 3 | 23% |
| Isolate 4 | 11% |
| Mixture of Isolates 1-5 | 82% |
| Control | 0% |

All cultures showed some settling of the biomass, but this was most pronounced in the mixed culture.

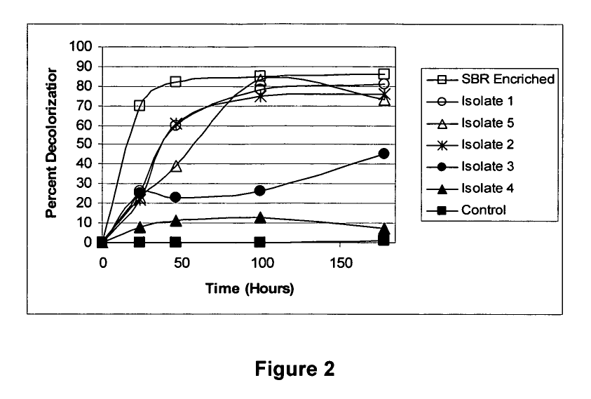

The decolorization of the strong pond influent over time was determined. The cultures were incubated under anaerobic conditions with 1% glucose, approximately, 1 gram calcium carbonate, and SSC at 35° C. All organisms were added at an approximate final concentration ranging from 1×10⁷ to 1×10⁸ CFU/mL. The organisms were: Isolate 1 (Pantoea agglomerans), Isolate 5 (Enterobacter pyrinus var 1), Isolate 2 (Enterobacter pyrinus var 2), Isolate 3 (Aeromonas enteropelogenes), and Isolate 4 (Pseudomonas plecoglossicida). The SBR enriched was a mixture of organisms taken from a sequencing batch reactor that had initially been inoculated with all of all above organisms (open squares). The influent was also treated with controls consisting of all of the components except for the addition of the organisms. The results are shown in FIG. 2, in which the percent decolorization was determined by the NCASI method, as described above.

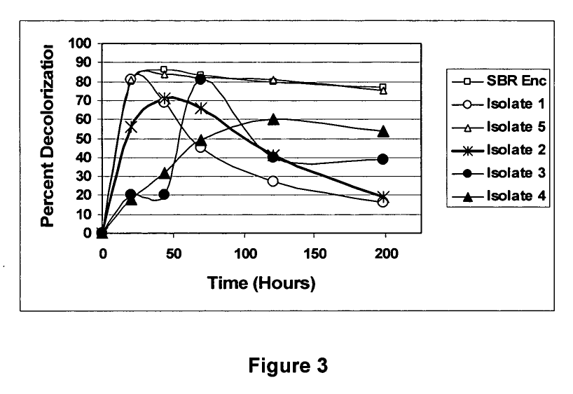

The isolates were also tested for their ability to grow under increased oxygen and mediate the destruction of the colored component in the strong pond. In particular, cultures containing filter sterilized strong pond waste with the addition of calcium carbonate, 1% glucose and SSC were aerated. All organisms were added at an approximate final concentration ranging from 1'10⁷ to 1×10⁸ CFU/mL. The organisms were: Isolate 1 (Pantoea agglomerans), Isolate 5 (Enterobacter pyrinus var 1), Isolate 2 (Enterobacter pyrinus var 2), Isolate 3 (Aeromonas enteropelogenes), and Isolate 4 (Pseudomonas plecoglossicida). The SBR enriched was a mixture of organisms taken from a sequencing batch reactor that had initially been inoculated with all of all above organisms. The reactions were carried out in 250 baffled Erlenmeyer flask with 50 mL of media at 35° C. The decolorization results over time are shown in FIG. 3. The percent decolorization was determined by the NCASI method. Most organisms gave an initial high rate of decolorization followed by a gradual increase in color. The exceptions were isolates 4 and 5 which are known to utilize similar compounds as a sole carbon source and may represent growth on the substrate.

Given that aeration on the above experiment may have been limited due to the rather gentile shaking of the flask and a high oxygen demand brought about by the added glucose, the experiment was repeated under conditions which would promote better aeration of the samples. Cultures containing filter sterilized strong pond waste were incubated in the presence of air in an orbital shaker (300 rpm) with the addition of calcium carbonated, 1% glucose and SSC. The reactions were carried out in 250 baffled Erlenmeyer flask with 10 mL of media at 35° C. for 74 hours. The results of color decolorization determined by the NCASI method, as described above, are shown in the following table.

Bacterial Destruction of the
Strong Pond Waste Under Aerobic Conditions*

| | Bacterial Species | | | | |
|---|---|---|---|---|---|
| | Isolate 1 | Isolate 5 | Isolate 2 | Isolate 3 | Isolate 4 |
| Percent | 67% | 46% | 47% | 53% | 35% |
| Color Loss | | | | | |

### Example 3

Consortia Development

Organisms were first divided into two major groups. The following tables provide the grouping of the organisms.

| | Organisms | | | | |
|---|---|---|---|---|---|
| Consortium | Isolate 1 | Isolate 2 | Isolate 3 | Isolate 5 | Isolate 4 |
| ENT | + | + | + | + | + |
| | Organisms | | | | |
| | | | | | Uniden- |
| Consortium | Isolate 9 | Isolate 8 | Isolate 7 | Isolate 6 | tified |
| Base | + | + | + | + | + |

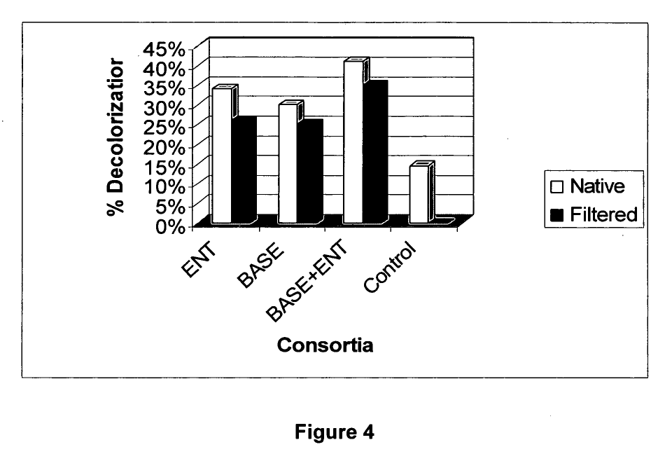

A combination of a consortium from one group with a consortium from the other group was tested. After 2-3 days growth at 35° C. under anaerobic conditions with 1% cellulose as the sole carbon source, these were assayed for decolorization of the “strong pond” waste stream. The strong pond waste (“native” material) was not filter sterilized before the addition of the organisms. The filtered strong pond waste was filter sterilized before the addition of the consortiums. All organisms were added at an approximate final concentration ranging from 1×10⁷ to 1×10⁸ CFU/mL. The combination of the two major groupings “ENT” and “Base” gave much better results when combined than when alone, as shown in FIG. 4. This combination worked well even the presence of the native population of bacteria that is found in the waste stream which would be represented by the “native” material. This material was not filter sterilized to remove indigenous populations of organism.

Further experiments showed that it is not necessary to include all ten microorganisms in order to obtain decolorization.

### Example 4

Anaerobic Sequencing Batch Reactors (AnSBRs) were operated for twenty five two-day cycles. AnSBRs were fed one of two highly colored waste-streams, namely Alkaline Pulp Mill, also known as Strong Pond effluent, or E Stage Bleach Plant filtrate from the Rayonier facility located in Jesup, Ga.

The AnSBRs were constructed from 1 liter glass containers with removable teflon lined metal covers. They were filled with 1 liter (˜1 kg) biologically active wood fiber waste mixed with fly ash, and lime obtained from a pit on the Rayonier site. The material was also used to isolate the microorganisms identified previously. The liquid waste was added to this biologically active mixture of wood waste fiber, fly ash, and lime (compost) from the Alkaline pulp mill waste. The AnSBRs were sealed and shaken at 100 rpm on a New Brunswick shaker at 25° C. Every 22 hours the reactors were removed from the shakers and allowed to settle for 60-90 minutes. Then 500 milliliters of supernatant was decanted and used to measure color per the NCASI method. This gave the reactors a hydraulic retention time or “cycle” of 48 hours. They were operated for 75 days.

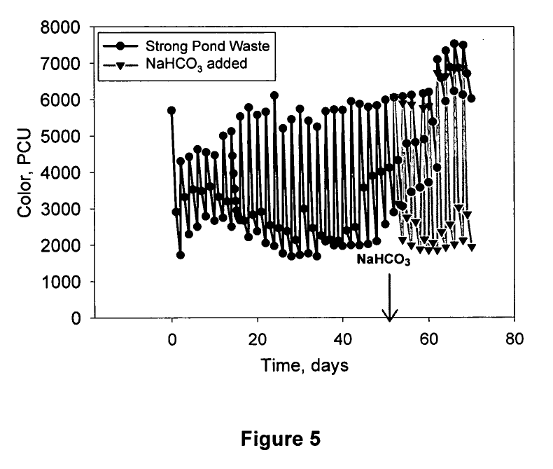

The results are provided in FIG. 5. The upper row of points represents the color (PCU) at the start of each SBR cycle. The initial color ranges form 4000-7500 PCU. The next lowest row of points represents the color in the supernatant (after 2 hours settling of the SBR) after 24 hours. The lowest row of points represents the supernatant of the SBR after 48 hours. This indicates the AnSBR removes color to 2000-4000 PCU, or 50%+ removal. The degree of removal achieved at the end of the cycle increased to almost 70% by the tenth cycle and continued at this level until the twenty second cycle. After the twenty second cycle, both the rate and degree of color removal decreased until the end of reactor operation (cycle 36), when color removal was less than 20%. At the end of cycle 26 (52^{nd} day) the lime content of the SBR solids was determined by titration to be less than 0.1%. This was significantly lower than the 2% lime content of the biologically active mixture of wood waste fiber, fly ash, and lime used to seed the reactor. This indicated that the anaerobic activity resulted in a depletion of alkalinity. On day 45-50, to overcome the depletion of lime, the reactor SBR contents were split, and one SBR received 35 mg/day of sodium bicarbonate (NaHCO₃). The addition of alkalinity resulted in an immediate improvement of color removal, with reductions of color increasing to over 70% by the end of the first cycle after bicarbonate addition and continuing at this level until the end of the study. During the cycling of the reactor, sulfate reduction and production of hydrogen sulfide was observed. The reactor operated in a REDOX range of −200 to −370 mV.

### Example 5

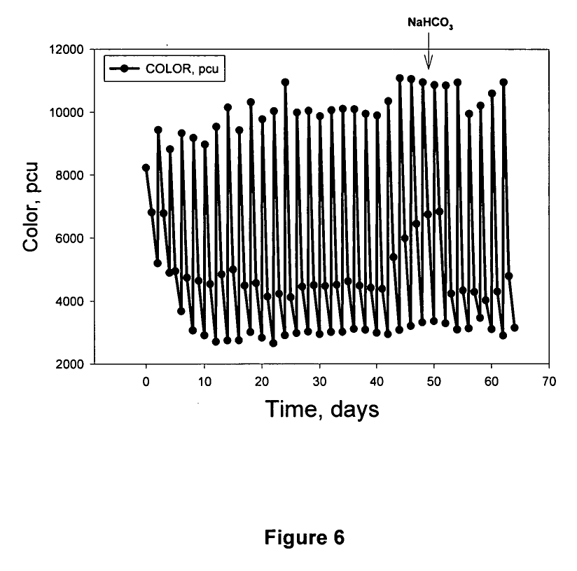

Anaerobic SBRs (AnSBRs), receiving bleach plant filtrate as feed, were operated for 66 days. Color removal by the biologically active mixture of wood waste fiber, fly ash, and lime, AnSBR receiving bleach plant filtrate is shown in FIG. 6. The upper level of points represents the AnSBr at the beginning of cycle, the middle row of points represents color after 24 hours, and the lowest row represents the color after 48 hours. Color removal began during the first cycle of SBR operation, with over 35% removal attained after the 2 day cycle. The degree of removal achieved by the end of the cycle increased to almost 70% by the tenth cycle and continued at this level until the end of the study. The rate of removal also appeared to increase during the first ten cycles as evidenced by the high degree of removal achieved during the first day of the cycle. By cycle ten, the majority of removal had been accomplished by the end of the first day of the cycle and little additional removal occurred during the final day of the cycle.

After the 20th cycle (40th day), the rate of color removal decreased as evidenced by the increasing colors at the end of the first day of each cycle. However, the color at the end of the second day of each cycle remained at less than 2,800 PCU. The lime content of the SBR solids was determined by titration to be less than 0.2%. This was significantly lower than the 2% lime content of the biologically active mixture of wood waste fiber, fly ash, and lime used to set up the reactor. This indicated that the anaerobic activity resulted in a depletion of alkalinity which occurred slightly earlier than observed for the strong pond effluent. To overcome the depletion of lime this AnSBR also received 35 mg/day of NaHCO₃. The addition of alkalinity resulted in an immediate improvement of color removal, with reductions of color increasing to over 70% by the end of the first cycle after bicarbonate addition and continuing at this level until the end of the study.

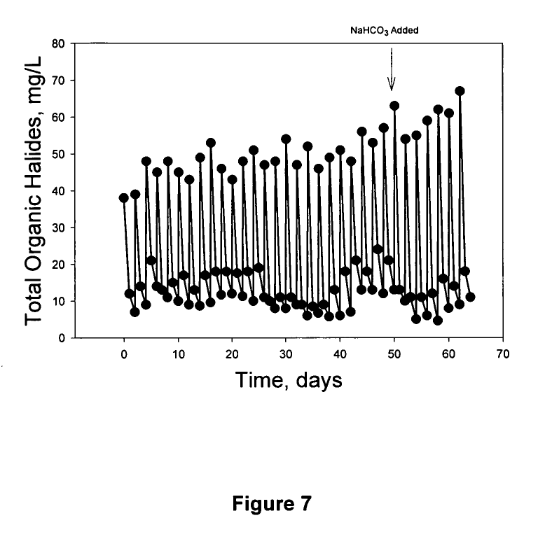

The removal of organic halides in the AnSBR treating bleach plant filtrate is presented in FIG. 7. The organic halides content of the bleach plant filtrate averaged 65 mg/L of which 21 mg/L was TOX (as chloride). The organic halides consisted primarily of mono and di-chlorinated phenols, mono and di-chlorinated benzoic acids, and chlorinated alkanes. A reduction in organic halides of over 75 percent was achieved during the first cycle of operation. The removal improved gradually until sustained TOX removal exceeding 90 percent was achieved. Effluent organic halide concentrations were below 10 ppm (4 ppm as TOX) except during the period when lime was depleted. At this time, the removal of organic halides decreased and effluent concentrations increased to over 30 mg/L. After the sodium bicarbonate was added, organic halide removal increased and the effluent concentrations decreased to below 10 ppm.

### Example 6

Small SBRs (1 liter) were seeded with varying masses of biologically active mixture of wood waste fiber, fly ash, and lime, and 0.5 liters of Alkaline pulp mill waste (Strong Pond effluent), yielding solids to liquid ratios ranging from 1:50 to 10:1. The AnSBRs were operated for 3.3 days. The samples were analyzed for color using the NCASI color method.

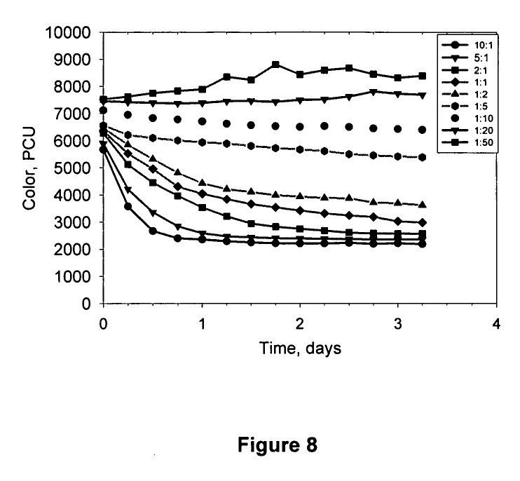

The results are shown in FIG. 8. The data shows that a higher mass of solids resulted in more color removal. At the lowest solid to liquid ratios (1:50 and 1:20) the color of the reactor contents increased slightly. As the solids to liquid ratio increased, the rate and degree of color removal increased. The best removal occurred in the reactors with 5:1 and 10:1 solids to liquid ratios.

In another experiment, Alkaline pulp mill wastewater was treated anaerobicly for three days, and then aerated to achieve oxygen concentrations exceeding 3 ppm as measured by an oxygen electrode. After aeration began, color increased to varying degrees. This phenomenon is termed color reversion. The rate and degree of color reversion was highest for the lowest solids to liquid ratio (1:50) and decreased as the solid to liquid ratio increased. At the highest ratios of 5:1 and 10:1 no color reversion was observed.

### Example 7

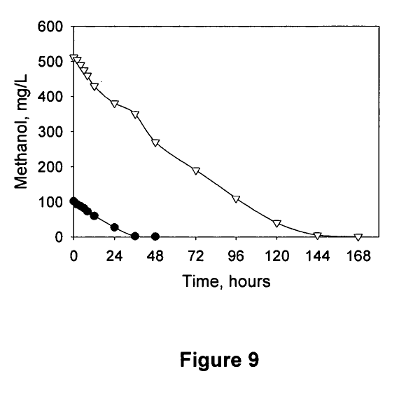

E Stage Bleached Plant Filtrate spiked with methanol (CH₃OH) at 100 mg/L and 500 mg/L was treated with waste wood fiber containing the microbial consortium in an AnSBR. The AnSBRs were covered to prevent sir stripping. The results are shown in FIG. 9. The data shows that CH₃OH was degraded by the waste wood fiber.

### Example 8

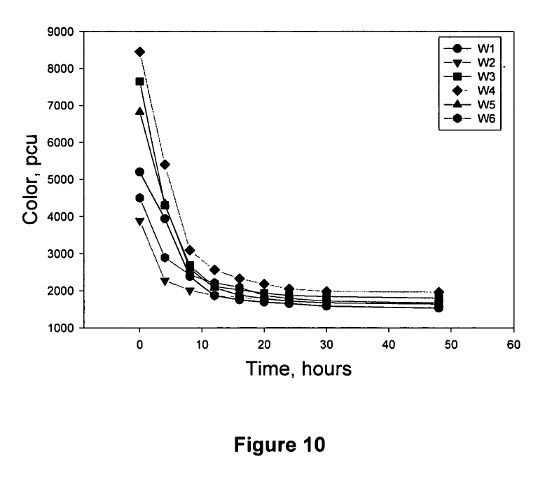

Wastewater was obtained from six additional pulp mills and was treated in SBRs containing biologically active wood fiber, fly ash, and lime from Rayonier and using the same protocols outlined previously. Two wastewaters were from Kraft mills and are designated W-1 (Wastewater 1) and W-2. Two samples were from fluff-pulp mills and are designated W-3 and W-4. The final two samples (W-5 and W-6) are from bleach-Kraft mills. As shown in FIG. 10, a large degree of color removal was achieved after 48 hours of SBR treatment of waste from Kraft pulp mill W-1. The rate and degree of color removal was similar for the various wastewaters and the Rayonier wastewaters.

### Example 9

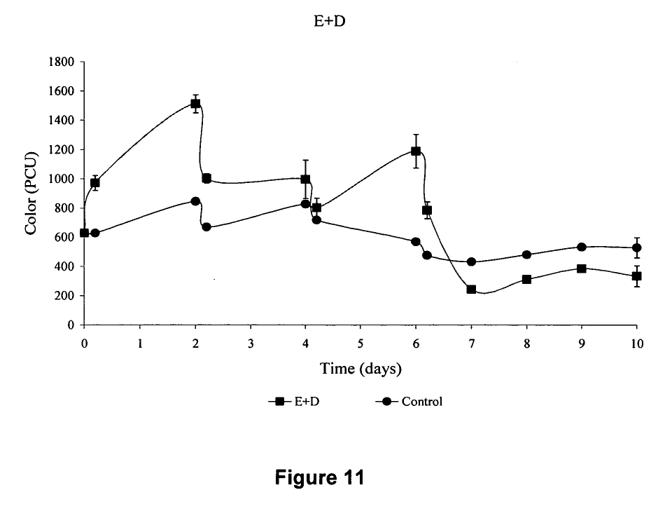

In most mills, the D & E Stage wastewaters are combined. FIG. 11 depicts the color removal achieved in the SBR laboratory simulations on the D&E Stage wastewater. The color removal exceeds 50%.

### Example 10

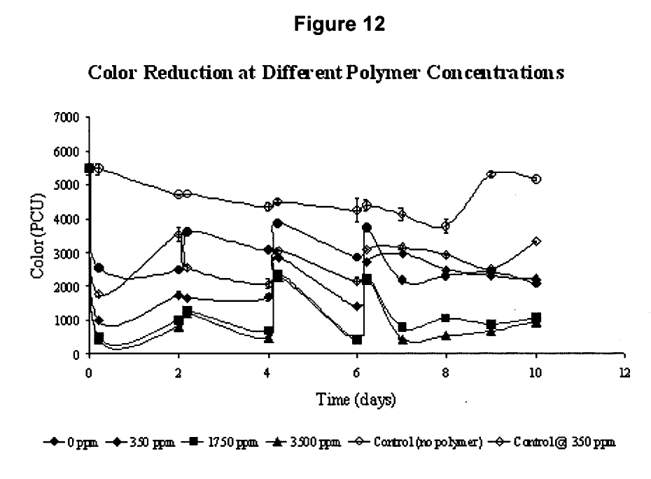

Additional experimental work was conducted to show the effect of flocculants on the color removal process. In the experiments, various levels of flocculants were added directly to SBR treatment with the mixed compost described previously. As shown in FIG. 12, the color removal proceeded at a rate of over 50%, even though the flocculent concentration exceeded 3500 mg/L, about ten times the concentration typically used.

### Example 11

In the current series of experiments, the color removal process is operated in a Down Flow, Periodic Batch Process. In this process, the mixed compost was loaded into a reactor with 6″ deep gravel under drain, composed of 2-3″ diameter granite or stone. Then the reactor received mixed compost. Finally, the reactor was initially charged with Strong Pond wastewater until it was full. The reactor size was 320 gallons, and processed 50 to 80 gallons per day for a 24 to 48-hour retention time. After acclimation the reactor operated as follows:
a. Bottom drain opened (through the gravel) under drain, and discharged for 1 to 2 hours. During that time the level of the reactor dropped as 50 to 80 gallons was discharged, but the compost solids were captured by the under drain so no solids were lost.
b. Tthe drain was closed and the partial void refilled in the reactor with 50 to 80 gallons fresh wastewater. The compost rose over the next 24 hours after this activity.
c. The reactor remained static while color removal took place.
d. Steps a-c were repeated allowing sufficient time for separation of compost within the reactor and for color reduction to occur, typically 12 to 48 hours.

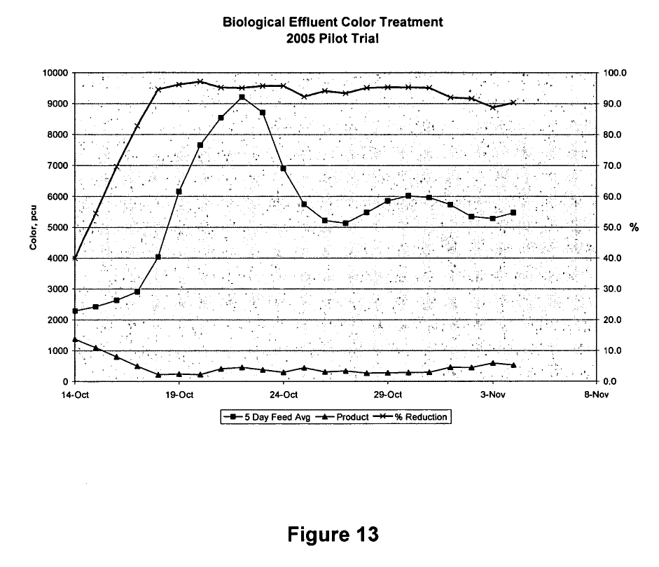

As shown in FIG. 13, the reactor was running for several days and removed color effectively.

While the invention has been described in detail and with reference to specific embodiments thereof, it will be apparent to one skilled in the art that various modifications and changes may be made therein without departing from the spirit and scope thereof.

1. A process of decolorizing a wastewater, comprising treating the wastewater with a composition comprising a strain of a microorganism selected from the group consisting of Aeromonas enteropelogenes, Enterobacter pyrinus, Klebsiella pneumoniae, Pantoea agglomerans, Proteus penneri, Pseudomonas geniculata, Pseudomonas monteili, and Pseudomonas plecoglossicida.

2. The process of claim 1, wherein the composition comprises a strain of two, preferably three, more preferably four, even more preferably five, most preferably six microorganisms selected from the group consisting of Aeromonas enteropelogenes, Enterobacter pyrinus, Klebsiella pneumoniae, Pantoea agglomerans, Proteus penner, Pseudomonas geniculata, Pseudomonas monteilii, and Pseudomonas plecoglossicida.

3. The process of claim 1, wherein the composition comprises the microorganism at a concentration of 1×10² to 1×10⁹ colony forming units (CFU)/mL, preferably 1×10⁶ to 1×10⁹ colony forming units (CFU)/mL.

4. A process of claim 1, wherein the composition comprises a strain of Aeromonas enteropelogenes.

5. The process of claim 4, wherein the Aeromonas enteropelogenes strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with
(SEQ ID NO: 1)
TGGAGAGTTTGATCCTGGCTCAGATTGAACGCTGGCGGCAGGCCTAACAC
ATGCAAGTCGAGCGGCAGCGGGAAAGTAGCTTGCTACTTTTGCCGGCGAG
CGGCGGACGGGTGAGTAATGCCTGGGAAATTGCCCAGTCGAGGGGGATAA
CAGTTGGAAACGACTGCTAATACCGCATACGCCCTACGGGGGAAAGCAGG
GGACCTTCGGGCCTTGCGCGATTGGATATGCCCAGGTGGGATTAGCTAGT
TGGTGAGGTAATGGCTCACCAAGGCGACGATCCCTAGCTGGTCTGAGAGG
ATGATCAGCCACACTGGAACTGAGACACGGTCCAGACTCCTACGGGAGGC
AGCAGTGGGGAATATTGCACAATGGGGGAAACCCTGATGCAGCCATGCCG
CGTGTGTGAAGAAGGCCTTCGGGTTGTAAAGCACTTTCAGCGAGGAGGAA
AGGTCAGTAGCTAATATCTGCTGACTGTGACGTTACTCGCAGAAGAAGCA
CCGGCTAACTCCGTGCCAGCAGCCGCGGTA
or its complementary strand.

6. A process of claim 1, wherein the composition comprises a strain of Enterobacter pyrinus.

7. The process of claim 6, wherein the Enterobacter pyrinus strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with
(SEQ ID NO: 2)
TGGAGAGTTTGATCCTGGCTCAGATTGAACGCTGGCGGCAGGCCTAACAC
ATGCAAGTCGAACGGTAACAGGAAGTAGCTTGCTACTTTGCTGACGAGTG
GCGGACGGGTGAGTAATGTCTGGGAAACTGCCTGATGGAGGGGGATAACT
ACTGGAAACGGTAGCTAATACCGCATAACGTCGCAAGACCAAAGAGGGGG
ACCTTCGGGCCTCTTGCCATCAGATGTGCCCAGATGGGATTAGCTAGTAG
GTGGGGTAACGGCTCACCTAGGCGACGATCCCTAGCTGGTCTGAGAGGAT
GACCAGCCACACTGGAACTGAGACACGGTCCAGACTCCTACGGGAGGCAG
CAGTGGGGAATATTGCACAATGGGCGCAAGCCTGATGCAGCCATGCCGCG
TGTATGAAGAAGGCCTTCGGGTTGTAAAGTACTTTCAGCGGGGAGGAAGG
CGGTGAGGTTAATAACCTCATCGATTGACGTTACCCGCAGAAGAAGCACC
GGCTAACTCCGTGCCAGCAGCCGCGGTA
or its complementary strand.

8. A process of claim 1, wherein the composition comprises a strain of Klebsiella pneumoniae.

9. A process of claim 8, wherein the composition comprises a strain of Klebsiella pneumoniae ozaenae.

10. The process of claim 9, wherein the Klebsiella pneumoniae ozaenae strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with
(SEQ ID NO: 3)
TGGAGAGTTTGATCCTGGCTCAGATTGAACGCTGGCGGCAGGCCTAACAC
ATGCAAGTCGAGCGGTAGCACAGAGAGCTTGCTCTCGGGTGACGAGCGGC
GGACGGGTGAGTAATGTCTGGGAAACTGCCTGATGGAGGGGGATAACTAC
TGGAAACGGTAGCTAATACCGCATAACGTCGCAAGACCAAAGTGGGGGAC
CTTCGGGCCTCATGCCATCAGATGTGCCCAGATGGGATTAGCTGGTAGGT
GGGGTAACGGCTCACCTAGGCGACGATCCCTAGCTGGTCTGAGAGGATGA
CCAGCCACACTGGAACTGAGACACGGTCCAGACTCCTACGGGAGGCAGCA
GTGGGGAATATTGCACAATGGGCGCAAGCCTGATGCAGCCATGCCGCGTG
TGTGAAGAAGGCCTTCGGGTTGTAAAGCACTTTCAGyGGGGAGGAAGGCG
TTAAGGTTAATAACCTTGkCGATTGACGTTACCCGCAGAAGAAGCACCGG
CTAACTCCGTGCCAGCAGCCGCGGTA
or its complementary strand.

11. A process of claim 9, wherein the composition comprises a strain of Klebsiella pneumoniae rhinoscleromatis.

12. The process of claim 11, wherein the Klebsiella pneumoniae rhinoscleromatits strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with
(SEQ ID NO: 4)
TGGAGAGTTTGATCCTGGCTCAGATTGAACGCTGGCGGCAGGCCTAACAC
ATGCAAGTCGAGCGGTAGCACAGAGAGCTTGCTCTCGGGTGACGAGCGGC
GGACGGGTGAGTAATGTCTGGGAAACTGCCTGATGGAGGGGGATAACTAC
TGGAAACGGTAGCTAATACCGCATAACGTCGCAAGACCAAAGTGGGGGAC
CTTCGGGCCTCATGCCATCAGATGTGCCCAGATGGGATTAGCTAGTAGGT
GGGGTAAyGGCTCACCTAGGCGACGATCCCTAGCTGGTCTGAGAGGATGA
CCAGCCACACTGGAACTGAGACACGGTCCAGACTCCTACGGGAGGCAGCA
GTGGGGAATATTGCACAATGGGCGCAAGCCTGATGCAGCCATGCCGCGTG
TGTGAAGAAGGCCTTCGGGTTGTAAAGCACTTTCAGCGGGGAGGAAGGCG
ATAAGGTTAATAACCTTGTCGATTGACGTTACCCGCAGAAGAAGCACCGG
CTAACTCCGTGCCAGCAGCCGCGGTA
or its complementary strand.

13. A process of claim 1, wherein the composition comprises a strain of Pantoea agglomerans.

14. The process of claim 13, wherein the Pantoea agglomerans strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with
(SEQ ID NO: 5)
TGGAGAGTTTGATCCTGGCTCAGATTGAACGCTGGCGGCAGGCCTAACAC
ATGCAAGTCGAACGGTAGCACAGAGAGCTTGCTCTCGGGTGACGAGTGGC
GGACGGGTGAGTAATGTCTGGGAAACTGCCTGATGGAGGGGGATAACTAC
TGGAAACGGTAGCTAATACCGCATAACGTCGCAAGACCAAAGAGGGGGAC
CTTCGGGCCTCTTGCCATCAGATGTGCCCAGATGGGATTAGCTAGTAGGC
GGGGTAATGGCCCACCTAGGCGACGATCCCTAGCTGGTCTGAGAGGATGA
CCAGCCACACTGGAACTGAGACACGGTCCAGACTCCTACGGGAGGCAGCA
GTGGGGAATATTGCACAATGGGCGCAAGCCTGATGCAGCCATGCCGCGTG
TGTGAAGAAGGCCTTCGGGTTGTAAAGCACTTTCAGCGGGGAGGAAGGCr
GTmCGGTTAATAACCGTGCTGATTGACGTTACCCGCAGAAGAAGCACCGG
CTAACTCCGTGCCAGCAGCCGCGGTA
or its complementary strand.

15. A process of claim 1, wherein the composition comprises a strain of Proteus penneri.

16. The process of claim 15, wherein the Proteus penneri strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with
(SEQ ID NO: 6)
TGGAGAGTTTGATCCTGGCTCAGATTGAACGCTGGCGGCAGGCCTAACAC
ATGCAAGTCGAGCGGTAACAGAmGAAAGCTTGCTTTCTTGCTGACGAGCG
GCGGACGGGTGAGTAATGTATGGGGATCTGCCCGATAGAGGGGGATAACT
ACTGGAAACGGTrGCTAATACCGCATrAyGTCTmmrGACCAAAGCAGGGG
CTCTTCGGACCTykyGCyATCrGATGAACCCAkATGGGATTAGCTAGTAG
GTGAGGTAAyGGCTCACCTAGGCGACGATCyCTAGCTGGTCTGAGAGGAT
GATCAGCCACACTGGrACTGAGACACGGyCCAGACTCCTACGGGAGGCAG
CAGTGGGGAATATTGCACAATGGGCGCAAGCCTGATGCAGCCATGCCGCG
TGTATGAAGAAGGCCTTAGGGTTGTAAAGTACTTTCAGCGGGGAGGAAGG
TGATAAGGTTAATACTCTTAGCAATTGACGTTACCCGCAGAAGAAGCACC
GGCTAACTCCGTGCCAGCAGCCGCGGTA
or its complementary strand.

17. A process of claim 1, wherein the composition comprises a strain of Pseudomonas geniculata.

18. The process of claim 17, wherein the Pseudomonas geniculata strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with
(SEQ ID NO: 7)
TGGAGAGTTTGATCCTGGCTCAGAGTGAACGCTGGCGGTAGGCCTAACAC
ATGCAAGTCGAACGGCAGCACAGArGAGCTTGCTCyTTGGGTGGCGAGTG
GCGGACGGGTGAGGAATACATCGGAATCTACTTTTTCGTGGGGGATAACG
TAGGGAAACTTACGCTAATACCGCATACGACCTACGGGTGAAAGCAGGGG
ACCTTCGGGCCTTGCGCGATTGAATGAGCCGATGTCGGATTAGCTAGTTG
GCGGGGTAAAGGCCCACCAAGGCGACGATCCGTAGCTGGTCTGAGAGGAT
GATCAGCCACACTGGAACTGAGACACGGTCCAGACTCCTACGGGAGGCAG
CAGTGGGGAATATTGGACAATGGGCGCAAGCCTGATCCAGCCATACCGCG
TGGGTGAAGAAGGCCTTCGGGTTGTAAAGCCCTTTTGTTGGGAAAGAAAT
CCAGCTGGCTAATACCCGGTTGGGATGACGGTACCCAAAGAATAAGCACC
GGCTAACTTCGTGCCAGCAGCCGCGGTA
or its complementary strand.

19. A process of claim 1, wherein the composition comprises a strain of Pseudomonas monteilii.

20. The process of claim 19, wherein the Pseudomonas monteilii strain comprises a DNA sequence encoding a 16S ribosomal RNA subunit, wherein the DNA sequence (a) has at least 70%, preferably 75%, more preferably 80%, even more preferably 85%, even more preferably 90%, and most preferably 95% identity with or (b) hybridizes under low stringency conditions, preferably medium stringency conditions, even more preferably high stringency conditions, and most preferably very high stringency conditions with
(SEQ ID NO: 8)
TGGAGAGTTTGATCCTGGCTCAGATTGAACGCTGGCGGCAGGCCTAACAC
ATGCAAGTCGAGCGGATGACGGGAGCTTGCTCCTTGATTCAGCGGCGGAC
GGGTGAGTAATGCCTAGGAATCTGCCTGGTAGTGGGGGACAACGTTTCGA
AAGGAACGCTAATACCGCATACGTCCTACGGGAGAAAGCAGGGGACCTTC
GGGCCTTGCGCTATCAGATGAGCCTAGGTCGGATTAGCTAGTTGGTGGGG
TAATGGCTCACCAAGGCGACGATCCGTAACTGGTCTGAGAGGATGATCAG
TCACACTGGAACTGAGACACGGTCCAGACTCCTACGGGAGGCAGCAGTGG
GGAATATTGGACAATGGGCGAAAGCCTGATCCAGCCATGCCGCGTGTGTG
AAGAAGGTCTTCGGATTGTAAAGCACTTTAAGTTGGGAGGAAGGGCAGTA
AGTTAATACCTTGCTGTTTTGACGTTACCGACAGAATAAGCACCGGCTAA
CTCTGTGCCAGCAGCCGCGGTA
or its complementary strand.

21-60. (canceled)
